(19) United States
(12) Patent Application Publication
(10) Pub. No.: US 2012/0230154 A1
(43) Pub. Date: Sep. 13, 2012

(54) Shot Clock Device

(76) Inventor: David B. Woycechowsky, (US)

(21) Appl. No.: 13/044,988

(22) Filed: Mar. 10, 2011

(51) Int. Cl. G04B 47/00

(52) U.S. Cl. 368/10

(57) ABSTRACT

A shot clock system wherein an indication of the shot clock signal is provided wirelessly to a basketball player to a personally mounted device. the personally mounted device is mechanically connected to the player and is located in her body, on her body and/or near her body. The sensory indication of the shot clock signal may be through any of the senses, such as sense of touch, sense of sight and/or sense of hearing.

### BACKGROUND OF THE INVENTION

1. Field of the Invention

The present invention relates to a timekeeping device for use by sports players and more particularly to shot clock devices for use by basketball players.

2. Description of the Related Art

Shot clock systems for use in basketball sporting games are known. FIG. 1 shows a representative prior art shot clock system 100 including: hoop 102; shot clock display 104; scoreboard 106; and basketball player 108. When a team goes on offense the shot clock counts down a predetermined time interval. For example, 42 seconds, 35 seconds and 30 seconds have all been used. The team on offense must take a shot at the basket (and it must at least hit the rim of the hoop) before the shot clock counts all the way down to zero. Shot clocks have also been used in other sports such as lacrosse and snooker.

Besides shot clocks, basketball and other sports have other kinds of countdown clocks. For example, in basketball each quarter of the game is counted down. In hockey, each period is counted down. In hockey, penalty periods, where a penalized player from one of the teams must leave the playing rink for a predetermined amount of time—during this time, the penalized team is said to be “shorthanded” and the non-penalized team is said to have a “power play.”

It can be strategically helpful for a sports player to know how much time remains on any of these kinds of sporting countdown clocks, especially when the time gets short. Conventionally, to the extent that players who are playing a sports game want to know how much time is left on a countdown clock, they take a look at a display of the clock positioned away from themselves somewhere off of the field of play. For example, in FIG. 1, basketball player 108 looks at shot clock 104 and sees that only 5 seconds remains. Therefore, he knows that he must shoot soon, or quickly pass to someone on his team who is in a better position to shoot, lest his team be penalized for violating the shot clock rule.

### BRIEF SUMMARY OF THE INVENTION

It is widely recognized that players must look at shot clocks, and other countdown clocks, when they are in the process of playing a sporting game. However, it is believed that this is not commonly considered as a problem and/or a situation that cries out for a technology-based solution. However, the present invention views this situation as a problem to be solved, and to be solved with new technology.

The present invention is directed to a countdown clock for a sports player that provides at least some indication of the countdown clock status directly to the player through a device mounted somewhere on the body of the player In this way, the player does not need to divert her attention to view the shot clock. For example, a basketball player might be provided a beep or a tingling or a visual indication that the shot clock has run down to five seconds. This way the basketball player will know that it is urgent to take action that will lead to a good shot at the basket, and the player does not need to divert his attention from the action on the basketball to do this.

Various embodiments of the present invention may exhibit one or more of the following objects, features and/or advantages:

(i) improved sporting play;

(ii) increased fan interest and ticket and advertising revenues; and.

(iii) wider adoption of shot clocks and other countdown clocks into sports where they would have previously been thought too distracting for the players.

According to one aspect of the present invention, a sports playing device is used by a sports player. The device includes: a frame; a wireless receiver module; a processing module; and a sensory indication module. The frame is sized, shaped, structured and/or located to be mechanically connected to the sports player The wireless receiver module, the processing module and the sensory indication module are all mechanically connected to the frame. The wireless receiver is structured and/or programmed to receive a wireless countdown clock signal corresponding to a time on a countdown clock relating to sports play and to generate a received signal corresponding to the wireless countdown clock signal. The processing module is connected in data communication with the wireless receiver and receives the received signal from the wireless receiver. The processing module is structured and/or programmed to process the received signal to generate an output signal corresponding to at least a portion of the received signal. The sensory indication module is connected in data communication with the processing module and receives the output signal from the processing module. The sensory device is structured, located, sized and/or shaped to deliver to the sports player a sensory indication corresponding to the output signal.

### BRIEF DESCRIPTION OF THE DRAWINGS

The present invention will be more fully understood and appreciated by reading the following Detailed Description in conjunction with the accompanying drawings, in which:

FIG. 1 is a perspective view of a prior art shot clock system;

FIG. 2A is a perspective view of a first embodiment of a personally mounted countdown clock device according to the present invention;

FIG. 2B is a perspective view of a second embodiment of a personally mounted countdown clock device according to the present invention;

FIG. 2C is an orthographic, eardrum side view of a third embodiment of a personally mounted countdown clock device according to the present invention;

FIG. 3 is a perspective view of a first embodiment of a shot clock system according to the present invention;

FIG. 4 is a schematic view of a first embodiment of a shot clock controller device according to the present invention;

FIG. 5 is a schematic view of a first embodiment of a player signal control module according to the present invention;

FIG. 6 is a partially cut-away, perspective view of a fourth embodiment of a personally mounted countdown clock device according to the present invention;

FIG. 7 is a perspective view of a fifth embodiment of a personally mounted countdown clock device according to the present invention; and

FIG. 8 is a perspective view of a sixth embodiment of a personally mounted countdown clock device according to the present invention;

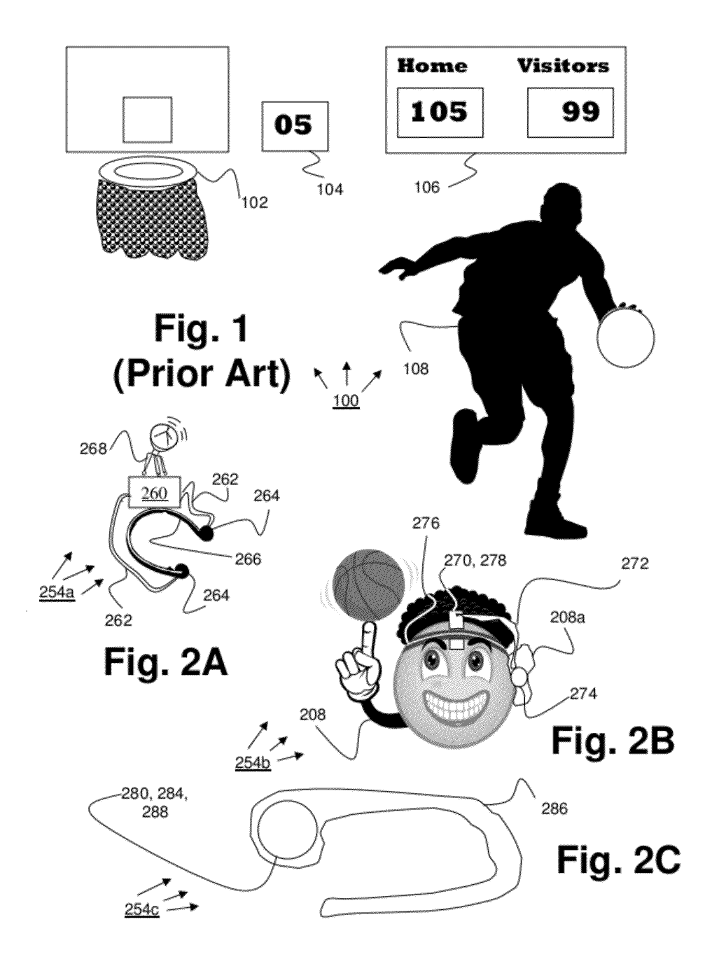

### DETAILED DESCRIPTION OF THE INVENTION

FIGS. 2A, 2B, 2C and 3-5 shows a shot clock system 200, according to the present invention, including: hoop 202; shot clock display 204; scoreboard 206; basketball player 208; shot clock controller device 250; transmitter 252; and personally mounted countdown clock device (or, simply, “personal device”) 254. As shown in FIG. 4, the shot clock controller device includes: clock module 290; start clock module 291; display module 292; and transmit signal module 293. The personal device may be constructed in many, many different ways. Three ways of constructing the personal device are respectively shown in FIGS. 2A, 2B and 2C. FIG. 2A personal device 254a includes: player signal control module 260; data communication lines 262; headphone style speakers 264; headphone frame member 266; and receiver 268. FIG. 2B personal device 254b includes: player signal control module 270; data communication lines 272; earbud speakers 274; headband member 276; and receiver 278. FIG. 2C personal device 254c includes: player signal control module 280; speaker 284; ear clip member 286; and receiver 288. As shown in FIG. 5, player signal control module 260,270,280 includes: power source sub-module 296; input signal sub-module 297; process signal sub-module 298; and output signal sub-module 299.

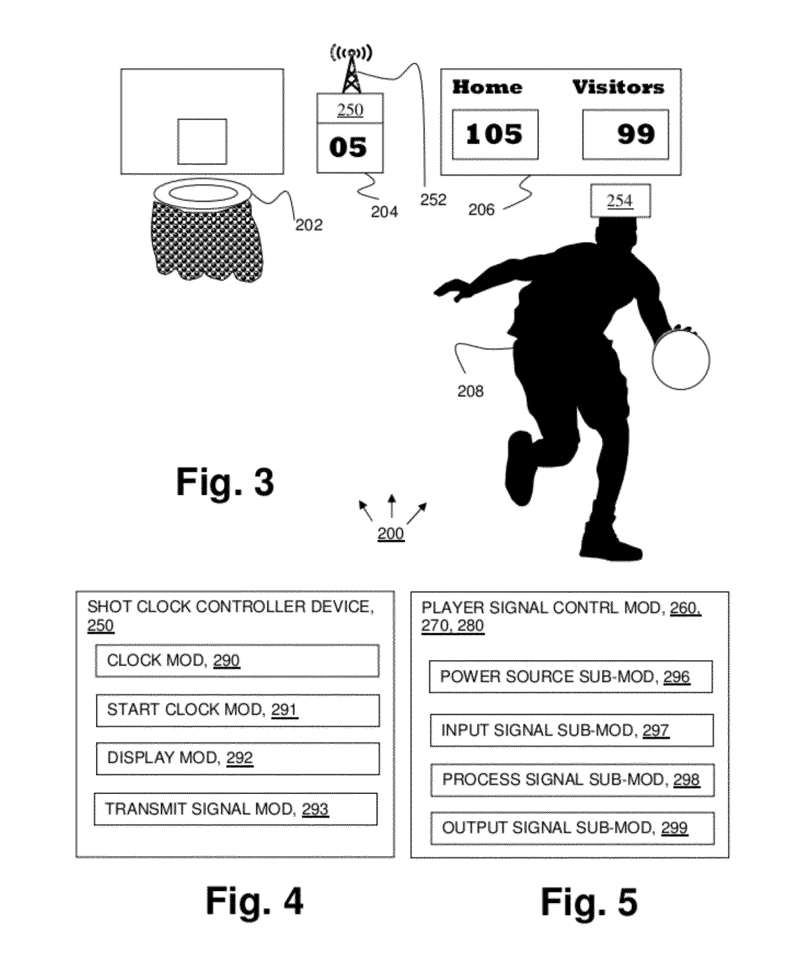

System 200 is different than prior art system 100 because it includes a wireless transmitter to transmit the shot clock signal (or at least a portion of it) to a personally mounted device on the players. The players get to hear the countdown of the shot clock (or at least a portion of it, or some other audio signal(s) like a beep or a buzz corresponding to a portion of the shot clock). Because the players get shot clock information delivered directly to their ears, they do not need to look up at the shot clock and can focus better on their game play. While FIG. 3 shows shot clock controller device 250 and wireless transmitter 252 as being located near traditional shot clock display 204, these components could alternatively be located elsewhere (in close proximity to each other or not). These components could even be distributed over multiple locations (in the same local area or not).

The operation of the shot clock controller module will now be explained with reference to FIG. 4. Clock module 290 includes a clock (preferably an electronic clock) that counts down the shot clock count down time starting from a predetermined time period once the clock has been started by the start clock module. The start clock module receives input to start the shot clock in any way currently known or to be developed in the future. For example, the start clock module could receive a signal from a human user (for example, one of the referees) or it could receive an automatic signal from some kind of intelligent module having appropriate sensors. Display module 292 receives the countdown time from the clock module on an ongoing basis and converts it into appropriate form to send to display 204 and sends it (over a wired connection or wirelessly) to display 204 so that the traditional display is made. Transmit signal module 293 receives the countdown time from the clock module on an ongoing basis and converts it into appropriate form to send to transmit wirelessly and sends it to transmitter 252 so that the wireless communication of the countdown can be made to the players. The entire countdown signal may be transmitted, or only a part of the countdown signal might be sent. For example, in some embodiments, the transmit signal module may be constructed to only send forth a wireless communication when the shot clock gets down to three seconds.

The transmitter receives an input signal from the transmit signal module of the shot clock controller device and transmits it in wireless form to the various personal device(s) worn by the various player(s). The physical form of the wireless transmission (for example, electromagnetic waves in the form of radio waves), the form of its modulation (for example FM frequency modulation) and/or the protocol used (for example, digital, analog, packetized, non-packetized, etc.) may take any forms now known or to be developed in the future. Of course, the range of the transmitter generally need not be more than a few hundred feet so long as the transmitter is located in close proximity to the field of play.

Exemplary operation of personal device 254 will now be explained with reference to FIGS. 2A and 5. Receiver 268 receives the wireless signal from the transmitter and sends it to input signal sub-module 297 of player signal control module 260. The input signal sub-module performs any necessary conditioning on the raw signal that may be needed to prepare it for processing. Process signal sub-module 298 processes the received signal to extract the data corresponding to the countdown information being conveyed. In some embodiments, this information may be as simple as a binary signal at, say, the three second mark that indicates that a simple alert should be sounded for the player. In other embodiments, this information may be, for example, a voice signal that counts down the entire countdown of the shot clock in a soothing human voice. Once the information is extracted by the player signal control sub-module, output signal sub-module 299 of player signal control module 260 converts it into an appropriate output signal for sending to speakers 264 through lines 262. For example, if the output signal sub-module 299 receives a simple, short-duration DC pulse every time the shot clock has counted down another 5 seconds, the output signal sub-module might convert these simple pulse into a simulated human voice, speaking the countdown in whatever language is selected by the player. As a further example, the output signal sub-module might convert these simple pulse into a sawtooth form beep or buzz. As yet a further example, the output signal sub-module might receive a voice counting down the whole countdown, as generated by the shot clock controller device and sent through the transmitter, receiver, input signal sub-module and process signal sub-module, so that the output signal sub-module does no processing, or very minor processing, like volume control. Of course, when the speakers receive the signal, they will transduce it into sound in the player's ears, and the player will thereby receive a sensory indication that effectively communicates to her what is happening with the shot clock.

In personal device 254b, shown in FIG. 2B, the receiver 278 and player control signal module 270 are built into the same housing, which is sized and shaped to be held in place within a head band. In personal device 254c, shown in FIG. 2C, the receiver 288, the speaker 284 and player control signal module 270 are built into the same housing, which is sized and shaped to be small enough to fit in an earbud style housing.

As a final note on the embodiments of FIGS. 2 through 5, it is noted that this system could be used for other countdown clocks and/or other sports entirely. For example, the personal device could also provide an indication of the countdown clock that counts down each quarter of the basketball game in addition to providing an indication of the shot clock. As a further example, the device could be used by a hockey player to help her track time remaining during penalty periods.

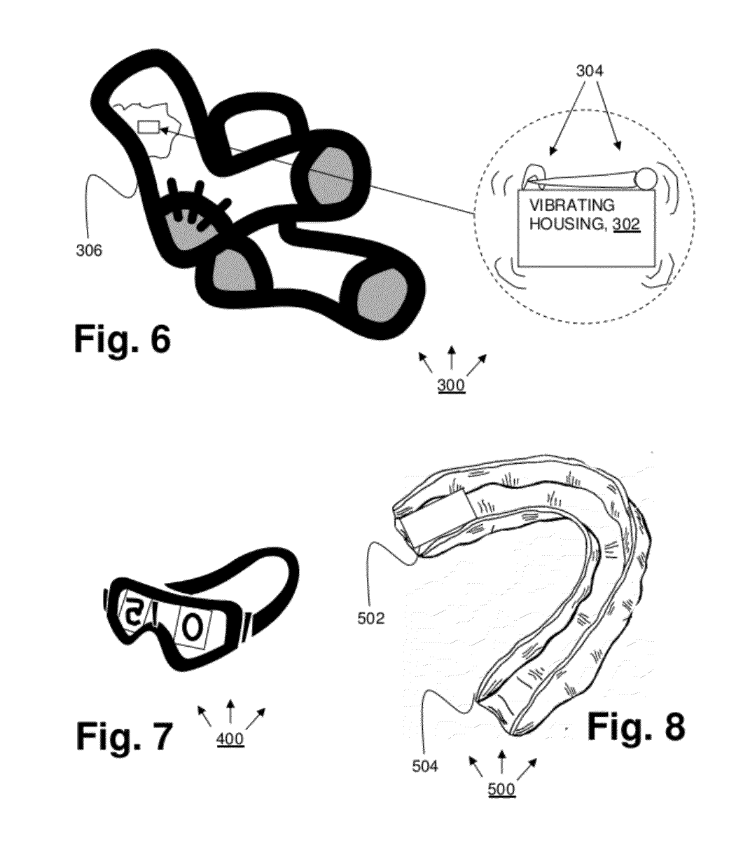

FIG. 6 shows personal device 300 including vibrating housing 302; sock pin 304 and athletic sock 306. In this embodiment, it is the player's sense of touch, rather than hearing, that receives the indication corresponding to the countdown clock.

FIG. 7 shows personal device 400 including goggles with a semi-transparent display of the countdown clock built into the goggles themselves. In this embodiment, it is the player's sense of sight, rather than hearing, that receives the indication corresponding to the countdown clock.

FIG. 8 shows personal device 500 including vibrating housing 502 and mouth guard 504. In this embodiment, the personally mounted device is actually located inside of the player's body (that is, inside her mouth) rather than at or near the surface of her body.

### DEFINITIONS

Any and all published documents mentioned herein shall be considered to be incorporated by reference, in their respective entireties. The following definitions are provided for claim construction purposes:

Present invention: means “at least some embodiments of the present invention,” and the use of the term “present invention” in connection with some feature described herein shall not mean that all claimed embodiments (see DEFINITIONS section) include the referenced feature(s).

Embodiment: a machine, manufacture, system, method, process and/or composition that may (not must) be within the scope of a present or future patent claim of this patent document; often, an “embodiment” will be within the scope of at least some of the originally filed claims and will also end up being within the scope of at least some of the claims as issued (after the claims have been developed through the process of patent prosecution), but this is not necessarily always the case; for example, an “embodiment” might be covered by neither the originally filed claims, nor the claims as issued, despite the description of the “embodiment” as an “embodiment.”

First, second, third, etc. (“ordinals”): Unless otherwise noted, ordinals only serve to distinguish or identify (e.g., various members of a group); the mere use of ordinals shall not be taken to necessarily imply order (for example, time order, space order).

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

Countdown clock signal: may correspond to only relatively small portion(s) of the entire countdown clock temporal countdown.

Unless otherwise explicitly provided in the claim language, steps in method or process claims need only be performed that they happen to be set forth in the claim only to the extent that impossibility or extreme feasibility problems dictate that the recited step order be used. This broad interpretation with respect to step order is to be used regardless of alternative time ordering (that is, time ordering of the claimed steps that is different than the order of recitation in the claim) is particularly mentioned or discussed in this document. Any step order discussed in the above specification, and/or based upon order of step recitation in a claim, shall be considered as required by a method claim only if: (i) the step order is explicitly set forth in the words of the method claim itself; and/or (ii) it would be substantially impossible to perform the method in a different order. Unless otherwise specified in the method claims themselves, steps may be performed simultaneously or in any sort of temporally overlapping manner. Also, when any sort of time ordering is explicitly set forth in a method claim, the time ordering claim language shall not be taken as an implicit limitation on whether claimed steps are immediately consecutive in time, or as an implicit limitation against intervening steps.

What is claimed is:

1. A sports playing device for use by a sports player, the device comprising:
a frame;
a wireless receiver module;
a processing module; and
a sensory indication module;
wherein:
the frame is sized, shaped, structured and/or located to be mechanically connected to the sports player;
the wireless receiver module, the processing module and the sensory indication module are all mechanically connected to the frame;
the wireless receiver is structured and/or programmed to receive a wireless countdown clock signal corresponding to a time on a countdown clock relating to sports play and to generate a received signal corresponding to the wireless countdown clock signal;
the processing module is connected in data communication with the wireless receiver and receives the received signal from the wireless receiver;
the processing module is structured and/or programmed to process the received signal to generate an output signal corresponding to at least a portion of the received signal;
the sensory indication module is connected in data communication with the processing module and receives the output signal from the processing module; and
the sensory device is structured, located, sized and/or shaped to deliver to the sports player a sensory indication corresponding to the output signal.

2. The device according to claim 1 wherein the sensory indication module comprises an audio speaker.

3. The device according to claim 1 wherein the frame comprises an earbud housing.
